(19) United States
(12) Patent Application Publication
(10) Pub. No.: US 2009/0108685 A1
(43) Pub. Date: Apr. 30, 2009

(54) Electronically Commutated Motor Control Retention Apparatus

(76) Inventor: David A. Curtis, Torrington, CT (US)

Correspondence Address: Haugen Law Firm, 1130 TCF Tower, 121 South Eighth Street, Minneapolis, MN, 55402, US

(21) Appl. No.: 12/257,974

(22) Filed: Oct. 24, 2008

Related U.S. Application Data
(60) Provisional application No. 61/000,605, filed on Oct. 26, 2007.

(51) Int. Cl. H02K 15/14

(52) U.S. Cl. 310/42; 29/596

(57) ABSTRACT

An electric motor assembly includes a motor housing having a main body portion with a central plane bisecting the main body portion into an upper portion and a lower portion. The motor housing further includes a first printed circuit board support structure having a plurality of slots and a second printed circuit board support structure having a top surface that is orientationally above at least a portion of the plurality of slots. The motor assembly further includes a printed circuit board having tabs which are configured and arranged to operably coordinate with the plurality of slots to thereby removably retain the printed circuit board at the motor housing and in contact with the top surface of the second printed circuit board support structure.

### CROSS-REFERENCE TO RELATED APPLICATIONS

This application claims priority to U.S. provisional patent application Ser. No. 61/000,605, filed on Oct. 26, 2007 and entitled “PCB Retention Method for Modular Air Moving System”, the content of which being incorporated herein in its entirety.

### FIELD OF THE INVENTION

The present invention relates to electronically commutated motors generally, and more particularly to apparatus and methods for securing a control system to an electrically commutated motor assembly, such as in the case of a motor for a modular air moving system.

### BACKGROUND OF THE INVENTION

Electronically commutated motors typically require some form of control circuitry in order to operate. This circuitry is usually contained on a printed circuit board (PCB) and housed in close proximity to the motor. Due to their fragile nature, circuit boards require stable mounting in order to achieve and maintain acceptable reliability. Conventional methods for retaining printed circuit boards at the motor housing include fasteners, post and staking arrangements, snap-fit standoffs, and grommet interference fits. Each of these methods, however, typically require significant additional space and/or extra components to accomplish the PCB retention. In continuing efforts to reduce material costs, assembly time and costs, and overall size of electrical motor assembly, and particularly in air-moving systems for computers and the like, such extra components and space are undesirable.

Accordingly, it is a principal object of the present invention to provide an apparatus and method for securing a PCB to a housing of electronically commutated motor through a simple and quick process, and without the need for separate fasteners.

It is another object of the present invention to provide an apparatus and method to retain a PCB at a motor housing which reduces cost and increases assembly line throughput, as well as reducing overall assembly size.

### SUMMARY OF THE INVENTION

By means of the present invention, a motor control system, such as a printed circuit board, may be secured to a housing of an electronically commutated motor without separate fasteners. Moreover, the control system attachment arrangement of the present invention reduces overall assembly size, and also reduces assembly time and cost by providing integrated mounting features at the printed circuit board and the electric motor housing.

In one embodiment, the electric motor assembly of the present invention includes a motor housing having a main body portion with a central plane bisecting the main body portion into an upper portion having an upper surface and a lower portion having a lower surface. The motor housing further includes a first printed circuit board support structure having a plurality of slots, with a first slot defining a first length and first direction, and a second slot defining a second length and second direction. The first and second directions may be substantially opposite to one another, and the first and second lengths may be unequal. The first and second slots are each further defined between respective upper and lower slot walls, with the lower slot walls being spaced from the central plane by at least a first dimension that is less than a second dimension defined between the central plane and respective ones of the upper slot walls. The motor housing preferably further includes a second printed circuit board support structure having a top surface that is spaced from the central plane by a third dimension which is greater than the first dimension. The second printed circuit board support structure may be disposed substantially between the first and second slots. The electric motor assembly may further include a printed circuit board having tabs which are configured and arranged to operably coordinate with the first and second slots to thereby removably retain the printed circuit board at the motor housing and in contact with the top surface of the second printed circuit board support structure.

### BRIEF DESCRIPTION OF THE DRAWINGS

FIG. 1 is a schematic view of an electric motor assembly of the present invention;

FIG. 2A is an isolation view of a portion of the electric motor assembly illustrated in FIG. 1;

FIG. 2B is an enlarged isolation view of the portion of the electric motor assembly illustrated in FIG. 2A;

FIG. 2C is an isolation view of a portion of the electric motor assembly illustrated in FIG. 1;

FIG. 3A is a schematic view of a portion of the electric motor assembly illustrated in FIG. 1;

FIG. 3B is an isolation end view of a portion of the electric motor assembly illustrated in FIG. 3A; and

FIG. 3C is an isolation end view of the portion of the electric motor assembly illustrated in FIGS. 3A and 3B.

### DETAILED DESCRIPTION OF THE PREFERRED EMBODIMENTS

The objects and advantages enumerated above together with other objects, features, and advances represented by the present invention will now be presented in terms of detailed embodiments described with reference to the attached drawing figures which are intended to be representative of various possible embodiments of the invention. Other embodiments and aspects of the invention are recognized as being within the grasp of those having ordinary skill in the art.

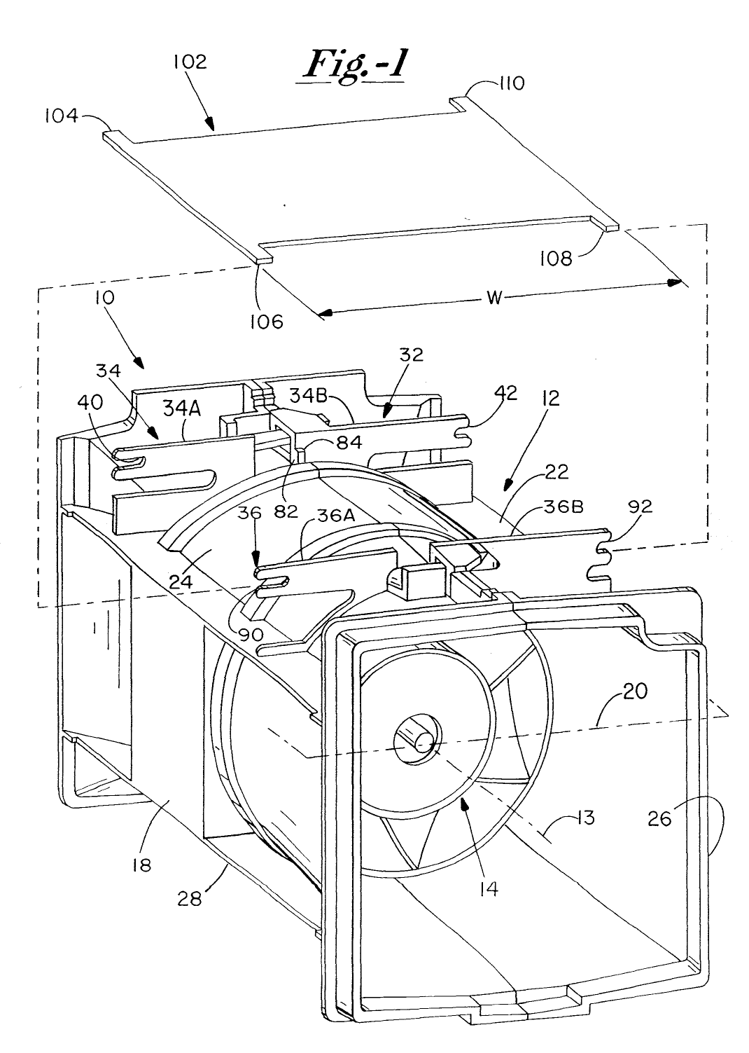

With reference now to the drawings, and first to FIG. 1, an electric motor assembly 10 includes a motor housing 12 for enclosing, for example, an electronically commutated motor 14. In the illustrated embodiment, motor housing 12 may comprise an aerodynamic shell for an air moving system, such as in the cooling system of electronic components in a computer system, such as a server, workstation, or the like. Motor 14 may be arranged and provided to move cooling air through a heated environment surrounding heat-generating electric components. Housings for electronic motors in a variety of other applications, however, may also be enhanced through the apparatus and methods of the present invention.

Motor housing 12 includes a main body portion 18 with a central plane 20 bisecting main body portion 18 into an upper portion 22 having an upper surface 24, and a lower portion 26 having a lower surface 28. For the purposes of this description, central plane 20 is considered to be oriented substantially “horizontally”, with upper portion 22 positioned “above” central plane 20, and lower portion 26 being positioned “below” central plane 20. Such orientational descriptions, however, are not intended to be limiting as to the overall orientation of electric motor assembly 10, but is rather used herein for the convenience of describing relative positions of the various features of electric motor assembly 10.

As illustrated in FIG. 1, motor housing 12 preferably further includes a first printed circuit board support structure 32 having a first slot 40 and a second slot 42. In this embodiment, first printed circuit board support structure 32 includes first and second support struts 34, 36 extending from upper surface 24 of main body portion 12. Each of support struts 34, 36 may include first and second support strut portions 34A, 34B, 36A, 36B, with respective pairs of support strut portions comprising first and second support struts 34, 36. In the illustrated embodiment, first and second support struts 34, 36 are longitudinally spaced from one another along axis 13.

First printed circuit board support structure 32 may be integrally formed with upper surface 24 of main body portion 18, such as through a cavity molding process, or similar conventional molding procedures. First printed circuit board support structure 32 may assume a variety of configurations, including one or more support struts positioned at motor housing 12. In one example, first printed circuit board support structure 32 may define a single structure having first and second slots disposed at substantially opposing ends thereof. In other embodiments, such as that illustrated in FIG. 1, first printed circuit board support structure 32 may be comprised of a plurality of distinct structures, such as support struts 34A, 34B, 36A, 36B.

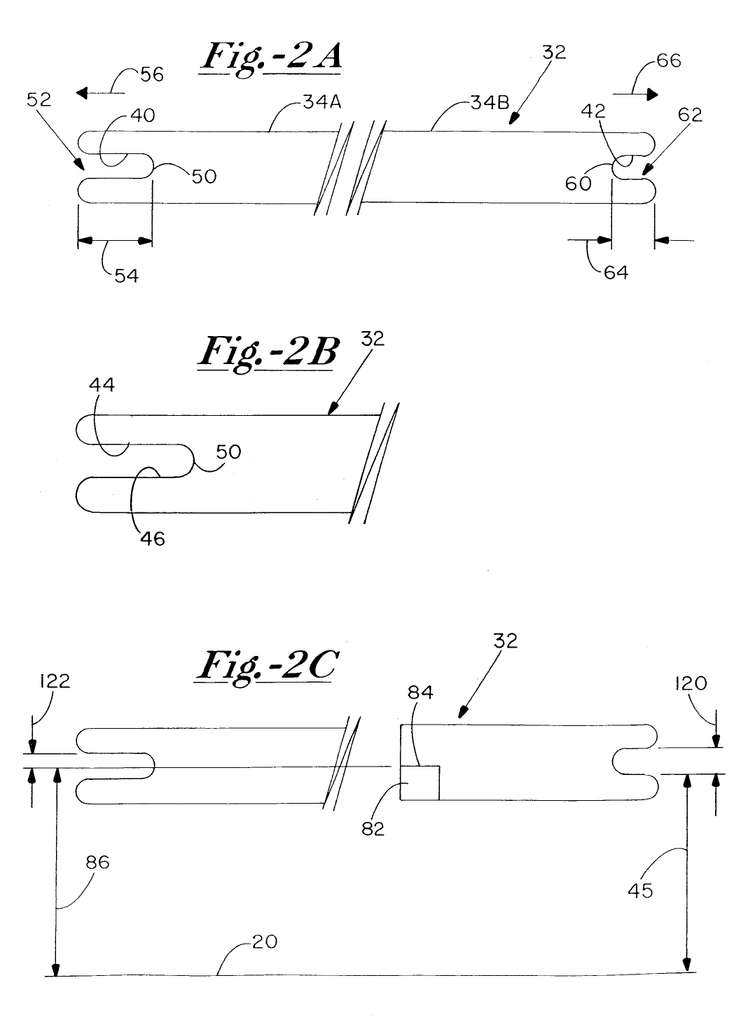

Support struts 34A, 34B of first printed circuit board support structure 32 are illustrated in FIG. 2A, wherein first slot 40 includes a first closed end 50 and a first open end 52 defining a first length 54 therebetween. In addition, a first direction 56 is defined as extending from first closed end 50 generally toward first open end 52. Such first direction is illustrated by direction arrow 56.

Support strut 34B of first printed circuit board structure 32 includes a second slot 42 having a second closed end 60 and a second open end 62 defining a second length 64 therebetween. In addition, a second direction 66 is defined as extending from second closed end 60 generally toward second open end 62. Such direction is illustrated by direction arrow 66. As will be described in greater detail hereinbelow, second direction 66 may be substantially opposite to first direction 56, and second length 64 may be less than first length 54.

As illustrated in the enlarged view of FIG. 2B, the slots of first printed circuit board support structure 32, such as first slot 40, are defined between upper and lower slot walls 44, 46. As illustrated in the drawings, upper and lower slot walls 44, 46 may be arranged such that first and second directions 56, 66 are substantially tangential to upper surface 24 of main body portion 18. Other arrangements or orientations for the slots of first printed board support structure 32 are contemplated by the present invention. In one example arrangement, lower slot wall 46 may be spaced from central plane 20 by a first dimension that is less than a second dimension defined from central plane 20 to upper slot wall 44. For example, where central plane 20 is substantially horizontal, upper slot wall 44 may be disposed vertically “above” lower slot wall 46.

With reference back to FIG. 1, motor housing 12 may further include a second printed circuit board support structure 82 having a top surface 84 that is spaced from central plane 20 by a third dimension 86 that is greater than first dimension 45 between lower slot wall 46 and central plane 20. Second printed circuit board support structure 82 may be integrally formed with upper portion 22 of motor housing 12, or may otherwise be secured to motor housing 12. Preferably, second printed circuit board support structure 82 is disposed substantially between first and second slots 40, 42, and in some embodiments is disposed substantially midway between first and second slots 40, 42. In the embodiment illustrated in FIG. 1, a plurality of second printed circuit board support structures 82 may be provided at motor housing 12, and may particularly be disposed at or adjacent to first and second support struts 34, 36 of first printed circuit board support structure 32. Other locations for second printed circuit board support structure 82 at motor housing 12, however, are contemplated by the present invention. For example, second printed circuit board support structure 82 may be positioned substantially between first slot 40 of first support strut 34 and second slot 92 of second support structure 36. Generally, it is desired that second printed circuit board support structure 82 be located at a position which provides support for a printed circuit board mounted at motor housing 12.

Second printed circuit board support structure 82 may be of a variety of dimensions and configurations, with the sole requirement being that upper surface 84 establish a non-damaging contact point with a printed circuit board or its associated componetry mounted at motor housing 12. In one embodiment, upper surface 84 may comprise about 2 cm² surface area.

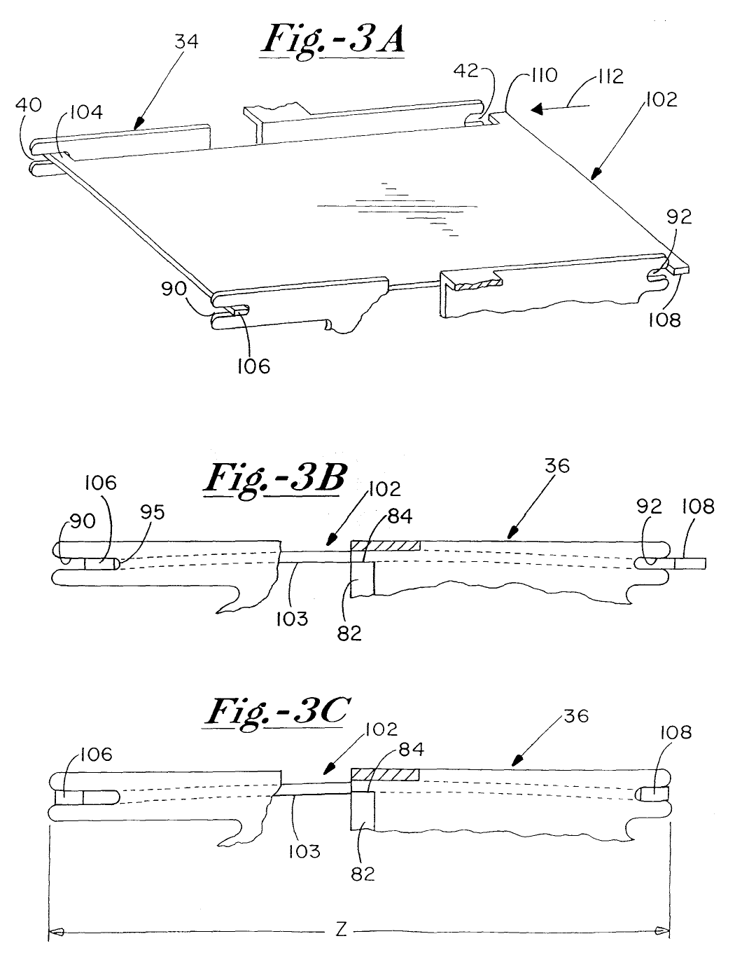

As illustrated in FIG. 1, electric motor assembly 10 further includes a printed circuit board 102 having tabs 104, 106, 108, 110 which are configured and arranged to operably coordinate with the slots of motor housing 12, such as slots 40, 90, 42, 92 to thereby removably retain printed circuit board 102 at motor housing 12. Slidable engagement of tabs 104-110 in respective slots 40, 42, 90, 92, as illustrated in FIGS. 1 and 3A-3C, removably retains printed circuit board 102 at first printed circuit board support structure 32, and in contact with upper surface 84 of second printed circuit board support structure 82.

As illustrated in FIG. 3A, tabs 104, 106 of printed circuit board 102 are first slidably engaged in slots 40, 90 of first printed circuit support structure 32, which first slots 40, 90 represent a pair of slots having first length 54. Printed circuit board 102 is then moved such that tabs 104, 106 come into contact with respective closed ends of first slots 40, 90. In this position, tabs 108, 110 may be brought into alignment with second slots 42, 92 of first and second strut supports 34, 36 of first printed circuit board support structure 32. An end elevational view of the arrangement illustrated in FIG. 3A is shown in FIG. 3B, wherein tab 106 is positioned in juxtaposition with closed end 95 of first slot 90 so that tab 108 may be brought into alignment with second slot 92. To removably secure printed circuit board 102 at first printed circuit board support structure 32, printed circuit board 102 is then moved in the direction depicted by direction arrow 112 such that tabs 108, 110 are slidably engaged with second slots 42, 92. This slidably engaged position of printed circuit board 102 is illustrated in FIG. 3C.

As further illustrated in FIGS. 3B and 3C, slidable engagement of tabs 104, 106, 108, 110 in respective slots 40, 42, 90, 92 causes lower surface 103 of printed circuit board 102 to come into contact with upper surface 84 of second printed circuit board support structure 2. Moreover, and as a result of the relative heights of upper surface 84 and lower slot wall 46 with respect to central plane 20, operable contact between lower surface 103 of printed circuit board 102 with upper surface 84 of second printed circuit board support structure 82 causes an upward deflection of printed circuit board 102. In some cases, such upward deflection may result in a curve or “bow” to printed circuit board 102 across its width dimension “W”, while in other embodiments, printed circuit board 102 may remain substantially planar in being upwardly deflected by a second printed circuit board support structure 82. Such upward deflection assists in retaining printed circuit board 102 in engagement within first and second slots 40, 42, 90, 92 by developing frictional resistance between tabs 104, 106, 108, 110 and respective upper slot walls 44 of first and second slots 40, 42, 90, 92.

Though second printed circuit board support structure 82 may assist in retaining printed circuit board 102 at motor housing 12, it is to be understood that further structures and/or devices may be implemented to further secure printed circuit board 102 to motor housing 12. For example, a cover device (not shown) may be provided with side portions that are mounted in relative close proximity to the edges of printed circuit board 102, so as to act as “back stops” against undesired movement of printed circuit board 102 relative to first and second slots 40, 42, 90, 92. Moreover, it is contemplated that other devices and methods may be employed to further secure printed circuit board 102 in engagement within first and second slots 40, 42, 90, 92.

In some embodiments, a slot dimension 120 may be about 3 mm, while a separation dimension 122 between upper surface 84 and upper slot wall 44 may be about 1.5 mm. Other dimensions and relative dimensions, however, for the slots in second printed circuit board support structure 82 are contemplated as being useful in the present invention.

As indicated above, first slot length 54 may preferably be greater than second slot length 64, with such an inequality enabling the sequential engagement of tabs 104, 106 in first slots 40, 90, followed by slidable engagement of tabs 108, 110 in second slots 42, 92. In the illustrated embodiment, width dimension “W” of printed circuit board 102 is less than or equal to a width dimension “Z” of first printed circuit board support structure 32. Accordingly, first slot length 54 must be at least as great as a width dimension of tabs 108, 110, and is preferably at least as great as a combined width dimension of tabs 104, 106 and tables 108, 110. In one embodiment, first slot length 54 may be about 8 mm, while second slot length 64 may be about 4 mm. Other dimensions, however, for first and second slot lengths 54, 64 may be employed as desired per application.

One aspect of the present invention is that at least two tabs be provided at printed circuit board 102, and preferably at substantially opposed ends thereof to most effectively secure printed circuit board 52 to motor housing 12. It should be understood that first and second slots 40, 42 may be provided and arranged at locations of motor housing 12 which enable operable cooperation with the plurality of tabs at printed circuit board 102. It should further be understood that, while printed circuit board 102 has been described herein with the inclusion of tabs 104, 106, 108, 110, and first printed circuit board support structure 32 provided with first and second slots 40, 42, 90, 92, a variety of engagement configurations and mechanisms may be employed. For example, the present invention contemplates respective features at motor housing 12 and printed circuit board 102 which may be slidably engaged with one another to effectuate deflecting contact with second printed circuit board support structure 82, as described above. Thus, the description of tabs at printed circuit board 102 and slots at first printed circuit board support structure 32 are not intended to be limiting as to the configuration of engagement features provided thereat.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different embodiments and that various modifications can be accomplished without departing from the scope of the invention itself.

What is claimed is:

1. An electric motor assembly, comprising:
(a) a motor housing having a main body portion with a central plane bisecting said main body portion into an upper portion having an upper surface and a lower portion having a lower surface, said motor housing further including:
(i) a first printed circuit board support structure having a plurality of slots, a first slot having a first closed end and a first open end defining a first length therebetween, and further defining a first direction from said first closed end toward said first open end, and a second slot having a second closed end and a second open end defining a second length therebetween, and further defining a second direction from said second closed end toward said second open end, said second direction being substantially opposite to said first direction and said first and second lengths being unequal, said first and second slots each being further defined between respective upper and lower slot walls, said lower slot walls being spaced from said central plane by at least a first dimension that is less than a second dimension from said central plane to respective ones of said upper slot walls; and
(ii) a second printed circuit board support structure having a top surface that is spaced from said central plane by a third dimension which is greater than said first dimension, said second printed circuit board support structure being disposed substantially between said first and second slots; and
(b) a printed circuit board having tabs which are configured and arranged to operably coordinate with said first and second slots to thereby removably retain said printed circuit board at said motor housing and in contact with said top surface of said second printed circuit board support structure.

2. An electric motor assembly as in claim 1, including an electronically commutated motor disposed within said motor housing.

3. An electric motor assembly as in claim 1 wherein said first printed circuit board support structure includes first and second support struts extending from said upper surface of said main body portion and being longitudinally spaced from one another.

4. An electric motor assembly as in claim 3 wherein said first and second support struts each include said first and second slots.

5. An electric motor assembly as in claim 1 wherein first and second ones of said tabs are disposed at substantially opposed ends of said printed circuit board.

6. An electric motor assembly as in claim 1 wherein said first and second directions are substantially tangential to said upper surface of said main body portion of said motor housing.

7. An electric motor assembly as in claim 2 wherein said printed circuit board includes control circuitry for said motor.

8. An electric motor assembly as in claim 1 wherein said tabs are integrally formed with said printed circuit board.

9. An electric motor assembly as in claim 1 in an air moving system.

10. An electric motor assembly, comprising:
(a) a printed circuit board having attachment means integrally formed therewith; and
(b) a motor housing having a main body portion with a central plane bisecting said main body portion into an upper portion having an upper surface and a lower portion having a lower surface, said motor housing further including:
(i) receptacle means for securing said printed circuit board to said housing, said receptacle means being configured and arranged to cooperate with said attachment means, such that said attachment means are slidably engageable with said receptacle means; and
(ii) support means for upwardly deflecting said printed circuit board when said printed circuit board is operably installed at said motor housing.

11. An electric motor assembly as in claim 10 wherein said receptacle means are oriented substantially tangentially to said upper surface of said main body portion.

12. A method for securing a printed circuit board to a housing of an electric motor assembly, said method comprising:
(a) providing receptacle means at said housing, wherein said receptacle means comprise a plurality of slots oriented substantially tangentially to an upper surface of said housing, and wherein a first slot length is greater than a second slot length;
(b) providing support means at said housing;
(c) providing attachment means at said printed circuit board, wherein said attachment means is arranged and configured to cooperate with said receptacle means;
(d) slidably engaging a first portion of said attachment means with a first slot having said first slot length; and
(e) subsequent to step (d), slidably engaging a second portion of said attachment means with a second slot having said second slot length, such that said printed circuit board is in operable contact with said support means, and such that said printed circuit board is upwardly deflected by operable contact with said support means.
